(19) United States
(12) Patent Application Publication
(10) Pub. No.: US 2005/0117250 A1
(43) Pub. Date: Jun. 2, 2005

(54) Magnetic recording head, head suspension assembly, magnetic recording apparatus, composite head, and magnetic recording and reproducing apparatus

(75) Inventor: Soichi Oikawa, Kawasaki-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/943,225

(22) Filed: Sep. 17, 2004

(30) Foreign Application Priority Data
Nov. 28, 2003 (JP) 2003-400794

(51) Int. Cl. G11B 5/127

(52) U.S. Cl. 360/125

(57) ABSTRACT

A magnetic recording head which records information on a recording medium by a vertical magnetic recording method, the magnetic recording head comprises a magnetic pole piece which generates a recording magnetic flux perpendicular to the recording surface of a recording medium and which includes a side parallel to the track width direction of the recording medium, and a concave part which is made concavely in the side parallel to the track width direction of the recording medium so as to have a longitudinal direction parallel to the recording surface, with the length of the magnetic pole piece in the track width direction of the recording medium being equal to 0.3 micrometers or less.

### CROSS-REFERENCE TO RELATED APPLICATIONS

This application is based upon and claims the benefit of priority from prior Japanese Patent Application No. 2003-400794, filed Nov. 28, 2003, the entire contents of which are incorporated herein by reference.

### BACKGROUND OF THE INVENTION

1. Field of the Invention

This invention relates to a magnetic recording apparatus, such as a hard disk drive, and a magnetic recording and reproducing apparatus. This invention further relates to a magnetic recording head, a composite head, and a head suspension assembly used in the magnetic recording and reproducing apparatus. More particularly, this invention relates to a vertical recording head and a magnetic recording and reproducing apparatus using the vertical recording head.

2. Description of the Related Art

In recent years, the vertical magnetic recording method has attracted attention in the technical field related to magnetic recording and reproducing apparatuses. In a vertical recording disk drive, it is common practice to use a single-magnetic-pole recording head (or write head) and a 2-layer vertical recording disk medium. The 2-layer vertical recording disk medium has a soft magnetic layer between a recording layer (or vertical magnetized layer) and the substrate.

In the longitudinal magnetic recording system using a ring head, only the magnetic field leaking from the gap in the write head can be applied to a recording medium. In contrast, in the vertical magnetic recording method, almost all of the magnetic field produced from the recording magnetic pole of the single-magnetic-pole head can be applied to the soft magnetic layer of the recording medium. Therefore, the vertical magnetic recording method can achieve a higher recording efficiency than the longitudinal magnetic recording method.

Normally, the magnetic moment of the magnetic pole piece of the write head is designed so as not to point to the medium as a whole. However, when the behavior of the magnetic moment becomes unstable, the residual magnetization component in the direction of the medium can develop in an unrecording operation. In the vertical magnetic recording method, the effect of the residual magnetization component is great. Even if the residual magnetization component in the direction of the medium is very small, the magnetic field produced from the magnetic pole piece is applied to the medium at a relatively large magnetic flux density. A case has been reported where the information recorded on the medium was erased because of such a phenomenon.

In recent years, there have been strong demands toward higher recording density. To meet the demands, the data track width of the disk medium has been getting narrower. Therefore, it becomes difficult to form a stable magnetic domain structure divided by magnetic walls, with the result that the behavior of the magnetic moment is liable to be unstable. Moreover, since the tip of the recording magnetic pole of the write head is shaped like a needle, the residual magnetization component heading toward the medium is liable to develop because of its shape magnetic anisotropy, which further increases the possibility that the information recorded on the medium will be destroyed.

Related techniques have been disclosed in Jpn. Pat. Appln. KOKAI Publication No. 3-113815 (reference 1). This reference has disclosed a method of controlling the magnetic domain structure of a magnetic head in such a manner that the magnetic domain of the magnetic film is controlled by forming a shallow groove in the magnetic pole magnetic film. The techniques of the reference are applicable to a single-magnetic-pole head. Use of the groove suppresses the movement of the magnetic wall caused by the application of an external magnetic field, which assures stable recording and reproducing operations.

Although the track width was about 50 micrometers (50,000 nanometers) at the time when the reference was disclosed, a track width of 0.3 micrometers (300 nanometers) or less has recently been realized. Therefore, the physical scales and various characteristics related to magnetic recording and reproducing operations at that time differ greatly from the present ones. That is, the size of the magnetic head described in reference 1 is larger. FIG. 4 of reference 1 shows the result of observing the tortoise-shaped reflux magnetic domain (closure domain) divided by magnetic walls (boundary lines in FIG. 4) by the Bitter method. Reference 1 has shown that the formation of such a reflux magnetic domain (closure domain) realizes a state where a magnetic flux will not leak outside unless the magnetic walls move.

In contrast, the size of the magnetic head related to the present invention is much smaller than the magnetic head of reference 1. Thus, the size of the magnetic domain boundary (the thickness of the magnetic wall is of the order of several tens of nanometers) cannot be ignored with respect to the size of the tip of the recording magnetic pole. Therefore, the magnetic head has a magnetic structure where the magnetic moment changes its direction continuously instead of a simple structure where the magnetic domain is divided by magnetic walls. Consequently, the residual magnetization component is produced by a subtle rotation of the magnetic moment, not by a change in the magnetic domain structure caused by the movement of the magnetic walls, which results in a state where the magnetic flux is liable to leak irregularly.

Even when the size of the tip of the magnetic pole had gotten closer to the thickness of the magnetic wall, the erasure of the recorded information by the residual magnetization component in the direction of the medium was suppressed by known measures. Recently, however, the track width has become narrower than 300 nanometers, with the result that a information erasure phenomenon caused by irregularly leaked magnetic flux has been observed. Thus, it becomes important to take measures against flux leakage aside from control of the magnetic domain structure.

As described above, the existing vertical magnetic recording head has disadvantages in that the effect of the residual magnetization component in an unrecording operation is so great that the information recorded on the disk medium is erased or changed. When the track width is made narrower to achieve high-density recording, such a problem is liable to arise. Therefore, suitable measures to cope with the problem have been desired.

### BRIEF SUMMARY OF THE INVENTION

According to an aspect of the present invention, there is provided a magnetic recording head which records information on a recording medium by a vertical magnetic recording method, the magnetic recording head comprises a magnetic pole piece which generates a recording magnetic flux perpendicular to the recording surface of a recording medium and which includes a side parallel to the track width direction of the recording medium, and a concave part which is made concavely in the side parallel to the track width direction of the recording medium so as to have a longitudinal direction parallel to the recording surface, with the length of the magnetic pole piece in the track width direction of the recording medium being equal to 0.3 micrometers or less.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view of an embodiment of a magnetic disk apparatus according to the present invention;

FIG. 2 schematically shows a sector format of the disk medium 2 in FIG. 1;

FIG. 3 is a perspective view showing a single-magnetic-pole vertical recording head used in a vertical magnetic recording method;

FIG. 4 schematically shows the flow of magnetic flux produced in recording at the recording head of FIG. 3;

FIG. 5 is a perspective view of a first embodiment of the magnetic pole piece 31 of FIG. 3;

FIG. 6 is a graph showing the result of combining the magnetic pole pieces (without the concave part 100) of sample (a) to sample (h) in Table 1 with disk (A) and measuring the positioning error and the number of repetitions of recording and reproducing;

FIG. 7 is a graph showing the result of combining the magnetic pole pieces (without the concave part 100) of sample (i) to sample (n) in Table 2 with disk (A) and measuring the positioning error and the number of repetitions of recording and reproducing;

FIG. 8 is a perspective view showing the magnetic pole piece 31 of the write head used in comparative example 3;

FIG. 9 is a graph showing the result of combining the magnetic pole pieces (without the concave part 100) of sample (c′) to sample (f′) with disk (A) and measuring the positioning error and the number of repetitions of recording and reproducing;

FIG. 10 is a graph showing the result of combining the magnetic pole pieces (with the concave part) of sample (c″) to sample (h″) and sample (1″) to sample (n″) with disk (A) and measuring the positioning error and the number of repetitions of recording and reproducing;

FIG. 11 schematically shows the direction of magnetic moment produced at the magnetic pole piece 31 of FIG. 5;

FIG. 12 is a graph showing the result of combining the magnetic pole pieces (with the concave part) of sample (e″1) to sample (e″6) with disk (A) and measuring the positioning error and the number of repetitions of recording and reproducing;

FIG. 13 is a perspective view of a third embodiment of the magnetic pole piece 31 in FIG. 3;

FIG. 14 is a graph showing the result of combining the magnetic pole pieces (with the concave part) of sample (e′″1) to sample (e′″6) with disk (A) and measuring the positioning error and the number of repetitions of recording and reproducing;

FIG. 15 is a perspective view of a fourth embodiment of the magnetic pole piece 31 in FIG. 3;

FIG. 16 is a graph showing the result of combining the magnetic pole pieces (with the concave part) of sample (c″″) to sample (n″″) with disk (A) and measuring the positioning error and the number of repetitions of recording and reproducing; and

FIG. 17 is a perspective view of a fifth embodiment of the magnetic pole piece 31 in FIG. 3.

### DETAILED DESCRIPTION OF THE INVENTION

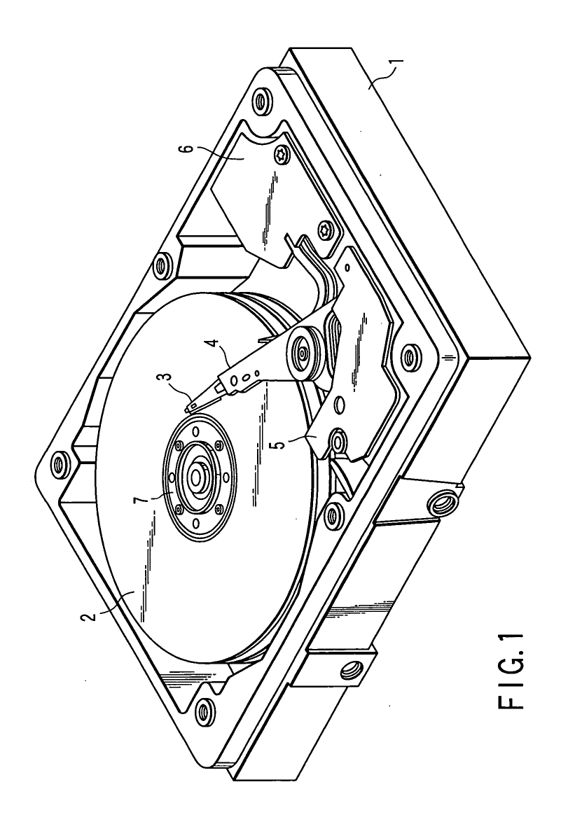

FIG. 1 is a perspective view showing an embodiment of a magnetic recording and reproducing apparatus and a magnetic recording apparatus (hereinafter, generically called a magnetic disk apparatus) according to the present invention. The magnetic disk apparatus has, in a housing 1, a disk medium 2, a magnetic head 3, a head suspension assembly (a suspension and an arm) 4 on which the magnetic head 3 is mounted, an actuator 5, and a circuit board 6.

The disk medium 2 is mounted on a spindle motor 7, which rotates the medium 2. On the disk medium 2, various types of digital data are recorded by a vertical magnetic recording method. The magnetic head 3 is a so-called composite head. In the magnetic head 3, a single-magnetic-pole write head according to the embodiment of the present invention and a read head using a GMR film or a TMR film are mounted on a common slider mechanism. The read head uses a shield MRT reproducing element or the like.

The head suspension assembly 4 supports the magnetic head 3 in such a manner that the magnetic head 3 faces the recording surface of the disk medium 2. The actuator 5 sets the magnetic head 3 in a given position on the disk medium 2 via the head suspension assembly 4. The circuit board 6, which has an head IC, generates a driving signal for the actuator 5 and a control signal for performing read and write control of the magnetic head 3.

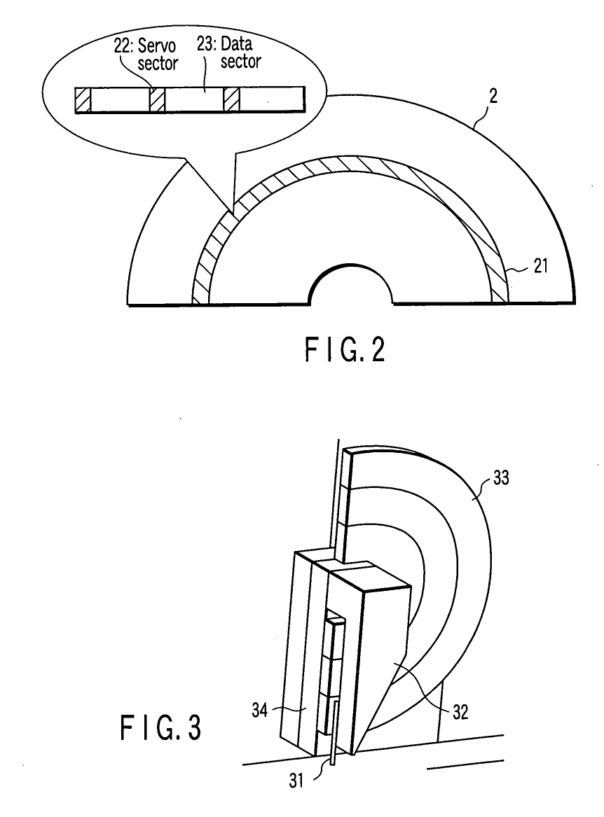

FIG. 2 schematically shows a sector format of the disk medium 2 in FIG. 1. The magnetic disk apparatus of FIG. 1 uses a sector servo method. In the sector servo method, each track 21 of the disk medium 2 is divided into servo sectors 22 and data sectors 23. In the servo sector 22, track positioning information has been recorded. The data sector 23 is an area for recording and reproducing user information. Once the information in the servo sector 22 is recorded, it will never be rewritten. When the user information is recorded, the data sector for recording the data is sought from the positioning information in the servo sector 22 and only the information in the target data sector is rewritten.

If the residual magnetization leaks from the magnetic head 3 in an unrecording operation, the information on the track 21 can be rewritten as a result of the leakage. When the information in the data sector 23 has been rewritten, the information in the part is only destroyed and has no effect on the other. However, when the information in the servo sector 22 has been rewritten, the positioning information is lost and therefore its influence is very serious.

Magnetic disk apparatuses have been constantly improved. To record as much information as possible on a disk with the same area, it is necessary to increase the data recording density. Use of the vertical magnetic recording method enables information to be recorded with much higher density. In the magnetic disk apparatus of the embodiment, too, the vertical magnetic recording method is used. The disk medium 2 used in the method has a structure where a underlayer with soft magnetism and an information recording layer with vertical magnetic anisotropy are stacked one on top of the other on a glass substrate or an aluminum substrate.

FIG. 3 is a perspective view showing a general configuration of the single-magnetic-pole recording head used in the vertical magnetic recording method. The write head includes a magnetic pole piece 31, a recording yoke section 32, an exiting coil 33, and a return yoke section 34. The magnetic pole piece 31 is generally shaped like a post composed of a soft magnetic thin film with high saturated magnetic flux density. The recording yoke section 32 concentrates magnetic flux on the magnetic pole piece 31. The exiting coil 33 excites magnetic flux by the applied recording current. The return yoke section 34 controls the path of the excited flux, thereby forming a magnetic path reaching the soft magnetic underlayer of the disk medium 2.

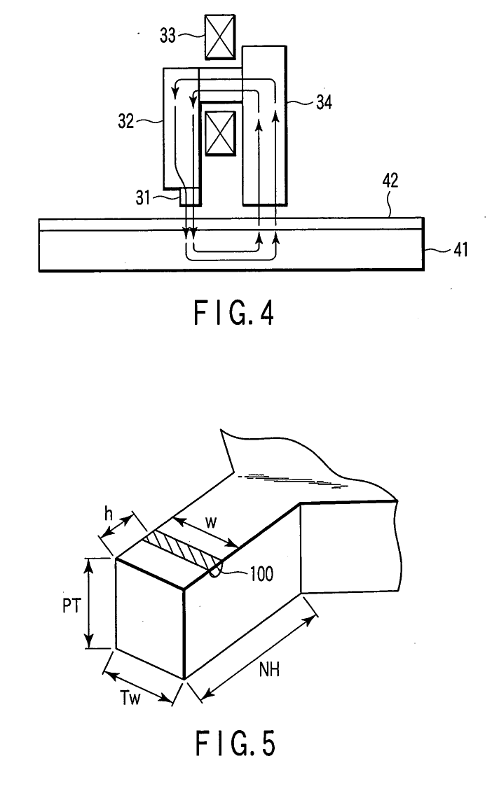

FIG. 4 schematically shows the flow of magnetic flux produced in recording at the write head of FIG. 3. In information recording, current is caused to flow through the exciting coil 33, thereby producing a magnetic flux. The produced magnetic flux concentrates on the magnetic pole piece 31, with the result that a large recording magnetic field is generated between the magnetic pole piece 31 and a soft magnetic underlayer 41. By the recording magnetic field, information is recorded in a vertical recording layer 42 of the disk medium 2. The magnetic flux entering the soft magnetic layer 41 forms a closed magnetic path returning to the recording yoke section 32 by way of the return yoke section 34 of the write head. Hereinafter, the magnetic pole piece 31 according to the embodiment of the present invention will be explained in detail.

### FIRST EMBODIMENT

FIG. 5 is a perspective view showing a first embodiment of the magnetic pole piece 31 in FIG. 3. In FIG. 5, NH is the length of the magnetic pole piece 31 in the direction in which a recording magnetic flux is generated (that is, the length of the side of the magnetic pole piece 31). NH is the neck height. Tw is the track width of the magnetic pole piece 31 and corresponds to the track width of the disk medium 2. PT is the length in the direction in which recording is done, that is, the film thickness of the magnetic pole piece 31.

In the first embodiment, a concave part 100 is made in one of the four sides of the magnetic pole piece 31. Specifically, in the first embodiment, the concave part 100 is made in one side parallel to the track width direction of the disk medium 2. The concave part 100 is formed into a concave shape which is parallel to the recoding surface of the disk medium 2 and has a longitudinal direction. Let the length of the concave part 100 in the longitudinal direction be w. It is desirable that the condition w≧½ Tw should be met, or that w should be equal to or larger than half of the track width. h is the distance between the center of the concave part 100 and the medium-facing side of the magnetic pole piece 31 and indicates the position in which the concave part is made. It is desirable that the condition h≦½ NH should be met or that the concave part 100 should be made closer to the disk medium 2 than the midpoint of the length of the magnetic pole piece 31 in the direction in which magnetic flux is generated.

The concave part 100 can be made by irradiating a convergent ion beam onto the magnetic pole piece 31 immediately after the film is formed. Alternatively, the concave part 100 may be made simultaneously with the process of forming a film for the magnetic pole piece 31.

Next, the results of experiments using the magnetic disk apparatus according to the first embodiment will be explained. In the first embodiment, information was recorded and reproduced onto and from the disk medium 2 by use of the magnetic head 3 and the positioning error on the disk medium 2 was measured. In experiments, the magnetic head 3 was used which included a write head having the magnetic pole piece 31 of FIG. 4 and a shield GMR head including a GMR element with a track width of 0.12 micrometers and having a shield-to-shield distance of 70 nanometers. The write head and read head were both mounted on the same slider.

A 2.5-inch vertical magnetic recording disk was used as the disk medium 2. In the 2.5-inch vertical magnetic recording disk, a soft magnetic underlayer made of CoZrNb, a 20-nanometer-thick vertical magnetic recording layer made of CoCrPt, and a 3-nanometer-thick carbon protective layer were stacked in that order on a glass substrate. Two types of disk medium 2 were prepared: one had a soft magnetic underlayer of 300 nanometers thick (called disk (A)) and the other had a soft magnetic underlayer thickness of 100 nanometers thick (called disk (B)). The operating characteristic of each disk was measured.

In operation tests, recording and reproducing were done on a specific track of the magnetic disk apparatus as many times as 10 rounds and the amount of head positioning error on the track was measured in each round until the number of repetitions of recording and reproducing had exceeded 20000 to 50000. In each track of the disk medium 2, 120 servo sectors were embedded intermittently in such a manner that the space between servo sectors was further divided into 500 data sectors. Since information was recorded only to the data sectors, recording was turned on and off 500 times each time a round was made on the track. Suppose no servo data is overwritten on the servo sectors. Next, as a comparative example, the results of experiments using a vertical recording head with the magnetic pole piece without the concave part 100 are shown.

### FIRST COMPARATIVE EXAMPLE

In this comparative example, eight magnetic heads were prepared which were composed of a CoFeNi soft magnetic single-layer films and differed from one another in the track width (Tw), pole thickness (PT), and neck height (NH) of the tip portion of the magnetic pole piece 31. Let the eight magnetic heads be sample (a) to sample (h), respectively. Table 1 lists the track widths, pole thicknesses, and neck heights of sample (a) to sample (h).

TABLE 1

| | a | b | c | d | e | f | g | h |
|---|---|---|---|---|---|---|---|---|
| Track | 0.4 | 0.3 | 0.25 | 0.25 | 0.2 | 0.15 | 0.15 | 0.12 |
| width | | | | | | | | |
| Tw (μm) | | | | | | | | |
| Film | 0.3 | 0.3 | 0.3 | 0.2 | 0.2 | 0.2 | 0.15 | 0.12 |
| thickness | | | | | | | | |
| (μm) | | | | | | | | |
| Neck | 0.3 | 0.3 | 0.3 | 0.3 | 0.3 | 0.3 | 0.3 | 0.3 |
| height | | | | | | | | |
| NH (μm) | | | | | | | | |

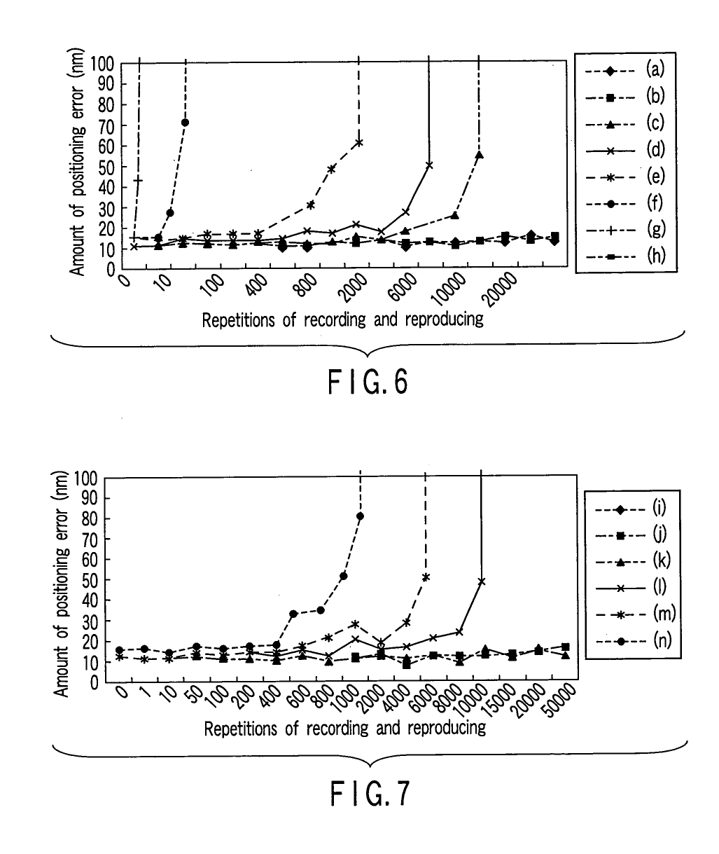

FIG. 6 is a graph showing the result of combining the magnetic heads (without the concave part) of sample (a) to sample (h) in Table 1 with disk (A) and measuring the positioning error and the number of repetitions of recording and reproducing. As shown in FIG. 6, when a head whose track width is 0.3 micrometers or more (sample (a) and sample (b)) was used, the head positioning error lay in a stable error range, regardless of the number of repetitions of recording and reproducing.

In contrast, with the track width smaller than 0.3 micrometers, as the track width and pole thickness are decreased, the positioning accuracy decreases with an increase in the number of repetitions of recording and reproducing (see sample (c) to sample (h)). When the number of recordings had exceeded a specific value, positioning could not be done at all and the test on the track to be measured was discontinued.

Investigation into the cause has shown that the reason why positioning could not be done is that the servo information disappeared in a part of the servo sectors. It is conceivable that, when the head in the comparative example passed over the servo sector after recording on the data sector, it erased the servo information on the disk medium 2, regardless of the unrecorded state with no recording current. That is, it is conceivable that an irregular residual magnetization component developed at the tip of the magnetic pole piece 31 in the unrecorded state in the probability of about once in 1000 times and this erased the servo information. Such a phenomenon developed in a higher probability as the size of the head tip portion become smaller. In sample (h), positioning could not be done after only one recording operation. The same held true even when disk (B) was combined with each of sample (a) to sample (h).

### SECOND COMPARATIVE EXAMPLE

Next, a second comparative example will be explained. In this comparative example, sample (i) to sample (n) with the neck height (NH) of head (c) to head (h) shortened to 0.2 micrometers were prepared and the same experiments as in the first comparative example were made. Table 2 lists the track widths, pole thicknesses, and heck heights of sample (i) to sample (n).

TABLE 2

| | i | j | k | l | m | n |
|---|---|---|---|---|---|---|
| Track | 0.25 | 0.25 | 0.2 | 0.15 | 0.15 | 0.12 |
| width | | | | | | |
| Tw (μm) | | | | | | |
| Film | 0.3 | 0.2 | 0.2 | 0.2 | 0.15 | 0.12 |
| thickness | | | | | | |
| (μm) | | | | | | |
| Neck | 0.2 | 0.2 | 0.2 | 0.2 | 0.2 | 0.2 |
| height | | | | | | |
| NH (μm) | | | | | | |

FIG. 7 is a graph showing the result of combining the heads (without the concave part) of sample (i) to sample (n) in Table 2 with disk (A) and measuring the positioning error and the number of repetitions of recording and reproducing. From FIG. 7, it is seen that, in each of the heads, the number of repetitions of recording and reproducing for a stable positioning operation increases as a result of the neck height being shortened from 0.3 micrometers to 0.2 micrometers. Particularly in sample (i) to sample (k), the amount of head positioning error does not get worse in a range of the number of repetitions of recording and reproducing up to 50000 times. It is conceivable that the factor improving the positioning error is a decrease in the irregular residual magnetization component as a result of shortening the neck height.

This can be explained on the basis of the shape magnetic anisotropy of the magnetic pole piece 31. Since in a long, narrow magnetic material, the demagnetizing field is smaller along the major axis and larger along the minor axis, the magnetic moment is liable to point along the major axis and less liable to point along the minor axis. Thus, shortening the neck height makes it possible to reduce the residual magnetization component heading toward the medium in the magnetic pole piece 31. Particularly in sample (i) to sample (k), since the residual magnetization component is suppressed sufficiently, it is seen that making the neck height equal to or shorter than the track width has the effect of decreasing the positioning error.

### THIRD COMPARATIVE EXAMPLE

Next, a third comparative example will be explained. This comparative example used a write head which gave the tip portion of the magnetic pole piece 31 a stacked structure with a nonmagnetic intermediate layer sandwiched between soft magnetic films.

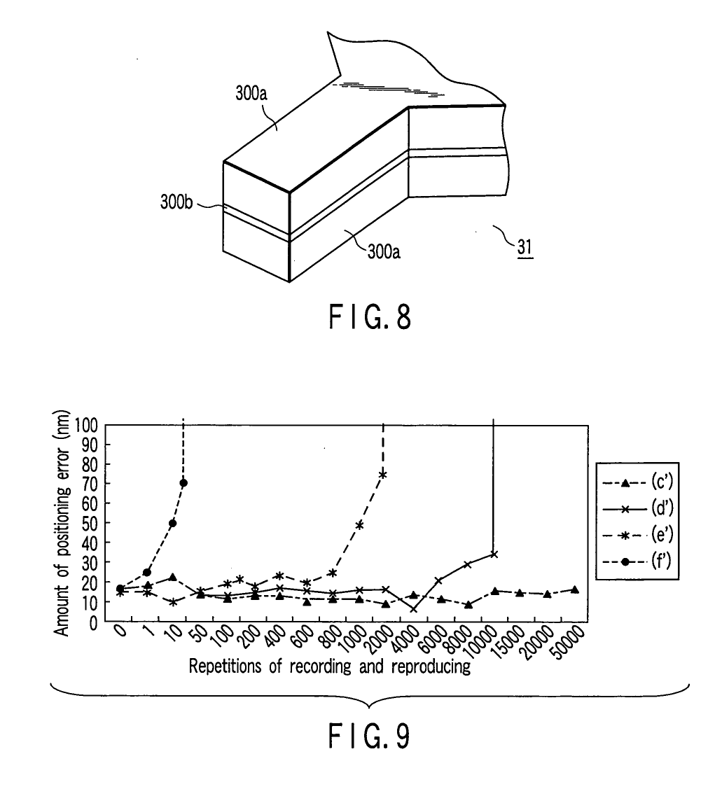

FIG. 8 is a perspective view of the magnetic pole piece 31 of the write head used in the third comparative example. The magnetic pole piece 31 includes a nonmagnetic intermediate layer 300b and soft magnetic films 300a sandwiching the nonmagnetic intermediate layer 300b between them.

In this comparative example, sample (c′) was prepared which was such that nonmagnetic carbon of 20 nanometers thick was sandwiched between two soft magnetic films of 0.15 micrometers thick and which had the same track width as sample (c) having a problem in the first comparative example. In addition, sample (d′) to sample (f′) were prepared which were such that nonmagnetic carbon of 20 nanometers thick was sandwiched between two soft magnetic films of 0.1 micrometers thick and which had the same track width as sample (c) to sample (f). Then, sample (c′) to sample (f′) were combined with disk (A) and operation tests as described above were carried out.

When the tip portion of the recording magnetic pole is stacked, if magnetization points in the track width direction, it is expected that an opposite parallel magnetization state is formed between the layers. Thus, since a magnetostatically more stable state than a single layer is obtained, the effect of suppressing the residual magnetization component heading toward the medium is expected.

FIG. 9 is a graph showing the result of combining the magnetic pole pieces (without the concave part) of sample (c′) to sample (f′) with disk (A) and measuring the positioning error and the number of repetitions of recording and reproducing. As shown in FIG. 9, it is seen that, in sample (c′) with soft magnetic films stacked, a stable positioning operation was continued, regardless of the number of recordings and an improvement was made to some extend. However, in sample (d′) to sample (f′), like in sample (d) to sample (f), positioning-related failures occurred as the number of recordings increased and therefore the test could not be continued. As compared with the first comparative example, the magnetization of the soft magnetic films became slightly stable. However, it is seen that there is a limit where the track width and pole thickness are smaller.

### Experimental Result Related to the Present Invention

In the first to third comparative examples, the concave part 100 has not been made in the magnetic pole piece 31. Next, in experimental results related to the present invention, an example of making measurements with the concave part 100 made in the magnetic pole piece 31 will be explained.

In this example, sample (c″) to sample (h″) obtained by making the concave part 100 in sample (c) to sample (h) of Table 1 respectively and sample (1″) to sample (n″) obtained by making the concave part 100 in sample (l) to sample (n) of Table 2 respectively were prepared. Table 3 lists the track widths, pole thicknesses, and neck heights of sample (c″) to sample (h″) and sample (l″) to sample (n″).

TABLE 3

| | c″ | d″ | e″ | f″ | g″ | h″ | l″ | m″ | n″ |
|---|---|---|---|---|---|---|---|---|---|
| Track | 0.25 | 0.25 | 0.2 | 0.15 | 0.15 | 0.12 | 0.15 | 0.15 | 0.12 |
| width | | | | | | | | | |
| Tw (μm) | | | | | | | | | |
| Film | 0.3 | 0.2 | 0.2 | 0.2 | 0.15 | 0.12 | 0.2 | 0.15 | 0.12 |
| thickness | | | | | | | | | |
| (μm) | | | | | | | | | |
| Neck | 0.3 | 0.3 | 0.3 | 0.3 | 0.3 | 0.3 | 0.2 | 0.2 | 0.2 |
| height | | | | | | | | | |
| NH (μm) | | | | | | | | | |

In this example, the concave part 100 was so made that h was about ¼ of the neck height NH and w was about ¾ or more of the track width Tw (that is, almost equal to Tw) in FIG. 5. The soft magnetic film of the magnetic pole piece 31 was made of CoFeNi. Instead of CoFeNi, for example, CoFe, CoFeN, NbFeNi, FeTaZr, or FeTaN may be used. Moreover, added elements may be further mixed with these magnetic materials as main components.

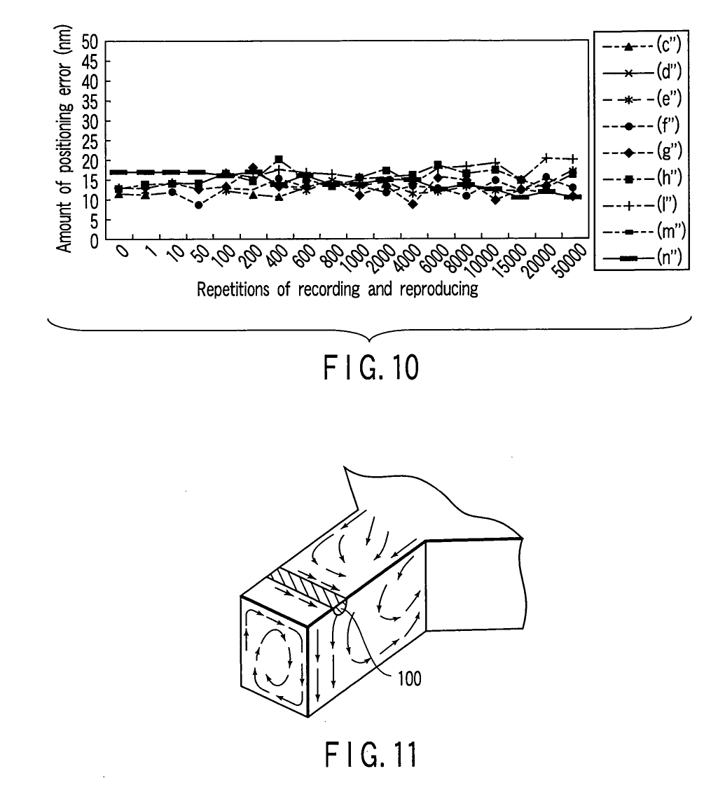

FIG. 10 is a graph showing the result of combining the magnetic pole pieces (with the concave part) of sample (c″) to sample (h″) and (l″) to (n″) with disk (A) and measuring the positioning error and the number of repetitions of recording and reproducing. As shown in FIG. 10, it is seen that, in all the samples, the positioning error was kept stable. That is, even with the track width that caused head-positioning-related failures as the number of recordings increased in the comparative example, a stable positioning operation can be carried out continuously, regardless of the number of recordings in this example.

Furthermore, even when these samples were combined with disk (B) whose soft magnetic underlayer was made thinner, a stable positioning operation was carried out similarly with all of the heads. Consequently, it is seen that making the concave part 100 in the magnetic pole piece 31 enables positioning control to be stabilized, almost regardless of the thickness of the soft magnetic film of the magnetic disk. It is conceivable that the reason such an effect is obtained is that making the concave part 100 in the side of the magnetic pole piece 31 produces shape magnetic anisotropy.

FIG. 11 schematically shows the direction of magnetic moment produced in the magnetic pole piece 31 of FIG. 5. In FIG. 11, when the magnetic moment attempts to point to the medium, magnetic charge appears at the surface of the concave part 100, increasing the magnetostatic energy. Therefore, the magnetic moment becomes liable to point in the direction parallel to the concave section 100. This tendency increases as the moment is getting closer to the concave part 100. As a result, the residual magnetization component heading toward the medium produced at the magnetic pole piece 31 is suppressed, which improves the stability of the magnetic pole piece 31 in an unrecording operation.

To sum up, in the first embodiment, the concave part 100 is made in the side of the magnetic pole piece 31 of the write head in such a manner that the concave part is parallel with the recording surface of the disk medium 2 and extends in the longitudinal direction. By doing this, shape anisotropy is produced in the magnetic pole piece 31, thereby controlling the direction of the magnetic moment at the tip of the magnetic pole piece 31 in an unrecording operation. This suppresses the residual magnetization component heading from the magnetic pole piece 31 to the medium, thereby preventing the residual magnetic field from leaking to the medium, which helps realize a highly reliable vertical recording head that assures a higher stability of the recorded information.

Specifically, according to the first embodiment, even when the magnetic pole piece 31 whose track width is 0.3 micrometers or less, whose pole thickness is 0.2 micrometers or less, and whose neck height is larger than the track width is used, instability in an unrecording operation can be suppressed, which makes it possible to provide a highly reliable vertical magnetic recording and reproducing apparatus. Accordingly, even in narrow track recording, the information recorded on the recording medium can be stored stably.

### SECOND EMBODIMENT

Hereinafter, a second embodiment of the present invention will be explained. In the second embodiment, the concave part 100 is made in the same side of the magnetic pole piece 31 as in FIG. 5. Sample (e″1) to sample (e″6) were prepared which were such that h and w were changed with respect to sample (e) in Table 1 (i.e., the track width Tw=0.2 micrometers, the pole thickness PT=0.2 micrometers, and the neck height NH=0.3 micrometers) as shown in Table 4. Then, the amount of head positioning error was measured for each sample.

TABLE 4

| | e″1 | e″2 | e″3 | e″4 | e″5 | e″6 |
|---|---|---|---|---|---|---|
| h (μm) | 0.07 | 0.07 | 0.1 | 0.1 | 0.15 | 0.15 |
| w (μm) | 0.14 | 0.1 | 0.14 | 0.1 | 0.14 | 0.1 |

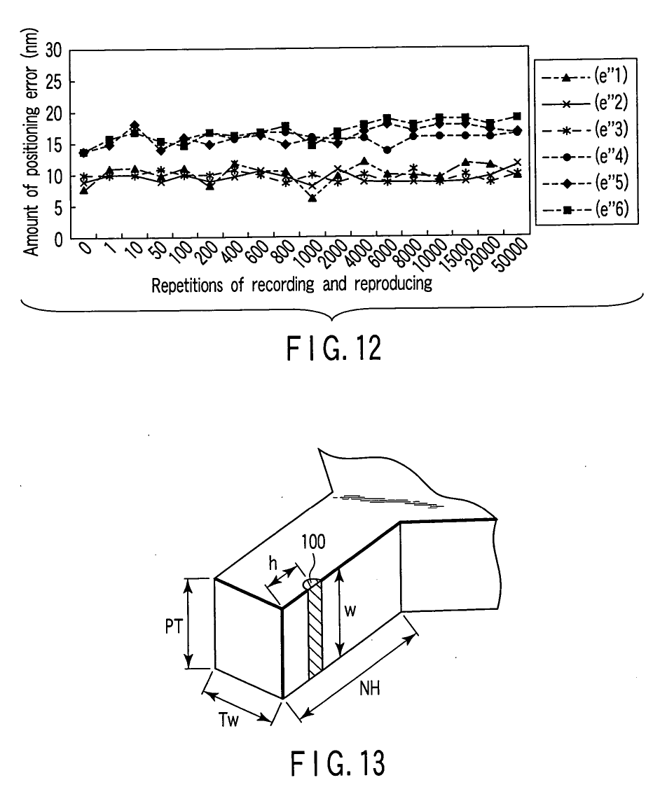

FIG. 12 is a graph showing the result of combining the magnetic pole pieces (with the concave part) of sample (e″1) to sample (e″6) with disk (A) and measuring the positioning error and the number of repetitions of recording and reproducing. From FIG. 12, it is seen that, although the positioning error is a little larger in sample (e″4) to sample (e″6) where the concave part 100 is farther away from the medium-facing side and has a narrower width, a stable positioning operation can be sustained continuously, regardless of the number of recordings as in the first embodiment. Moreover, even with a combination with disk (B) with a thinned soft magnetic underlayer, a similarly stable positioning operation was carried out for all of the heads. Accordingly, it is seen that, in the second embodiment, too, positioning control can be stabilized, almost regardless of the thickness of the soft magnetic film of the magnetic disk.

In sample (e″4) to sample (e″6), it is conceivable that the positioning error increased because of a decrease in the effect of giving shape anisotropy as a result of shortening the concave part and a decrease in the effect of controlling the magnetizing direction near the medium-facing side as a result of the concave part getting farther away from the medium-facing side. From this, to secure a sufficient stability of the magnetic pole piece 31 in an unrecording operation by suppressing sufficiently the residual magnetization component heading toward the medium in the magnetic pole piece 31, it is considered effective to make the height h of the concave part 100 equal to or less than half of the neck height NH and the length w of the concave part 100 equal to or less than half of the track width Tw.

Furthermore, as a result of further investigation under similar conditions, examination of the amplitude of the servo signal after 10000 recording and reproducing tests has shown that there was a 10% variation in the amplitude per round in sample (e″4) to sample (e″6). In contrast, in sample (e″1) to sample (e″3), a variation in the amplitude decreased to 7% or less per round. From this, it is seen that, to a certain extent, the second embodiment has the effect of suppressing a variation in the amplitude.

### THIRD EMBODIMENT

FIG. 13 is a perspective view showing a third embodiment of the magnetic pole piece 31 of FIG. 3. In the third embodiment, the concave part 100 is made in the side perpendicular to the track width direction of the disk medium 2, that is, in the bit length direction. As in FIG. 5, the concave part 100 is parallel to the recording surface of the disk medium 2 and has a longitudinal direction. In the third embodiment, the concave part 100 was made in sample (e) in Table 1 (i.e., the track width Tw=0.2 micrometers, the pole thickness PT−0.2 micrometers, and the neck height NH=0.3 micrometers) as shown in FIG. 13. Then, sample (e′″1) to sample (e′″6) were prepared which were such that h and w were changed as shown in Table 5. The same materials as in the first embodiment may be used for the composition of the soft magnetic film of the magnetic pole piece 31 of each sample. Then, the amount of head positioning error was measured for each sample.

TABLE 5

| | e″′1 | e″′2 | e″′3 | e″′4 | e″′5 | e″′6 |
|---|---|---|---|---|---|---|
| h (μm) | 0.07 | 0.07 | 0.1 | 0.1 | 0.15 | 0.15 |
| w (μm) | 0.14 | 0.1 | 0.14 | 0.1 | 0.14 | 0.1 |

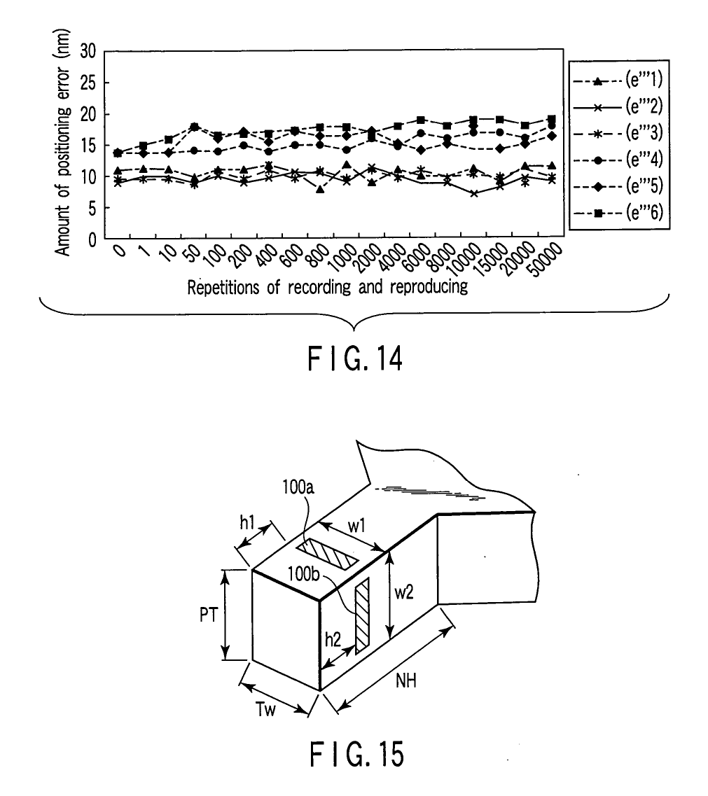

FIG. 14 is a graph showing the result of combining the magnetic pole pieces (with the concave part) of sample (e′″1) to sample (e′″6) with disk (A) and measuring the positioning error and the number of repetitions of recording and reproducing. From FIG. 14, it is seen that, although the positioning error is a little larger in sample (e′″4) to sample (e′″6) where the concave part 100 is farther away from the medium-facing side and has a narrower width, a stable positioning operation can be sustained continuously, regardless of the number of recordings as in the second embodiment. Moreover, even with a combination with disk (B), a similarly stable positioning operation was carried out for all of the heads. Accordingly, it is seen that, in the third embodiment, too, positioning control can be stabilized, almost regardless of the thickness of the soft magnetic film of the magnetic disk.

In sample (e′″4) to sample (e′″6), it is conceivable that the positioning error increased because of a decrease in the shape anisotropy. From this, to secure a sufficient stability of the magnetic pole piece 31 in an unrecording operation by suppressing sufficiently the residual magnetization component heading toward the medium in the magnetic pole piece 31, it is considered effective to make the height h of the concave part 100 equal to or less than half of the neck height NH and the length w of the concave part 100 equal to or less than half of the track width Tw.

Furthermore, as a result of further investigation under similar conditions, examination of the amplitude of the servo signal after 10000 recording and reproducing tests has shown that there was a 10% variation in the amplitude per round in sample (e′″4) to sample (e′″6). In contrast, in sample (e′″1) to sample (e′″3), a variation in the amplitude decreased to 7% or less per round. From this, it is seen that, to a certain extent, the third embodiment has the effect of suppressing a variation in the amplitude.

Furthermore, in the third embodiment, it is expected that making the concave part 100 in the position shown in FIG. 13 improves the recording and reproducing characteristics, including recording resolution and medium noise, and makes the surface recording density higher than in FIG. 5. In comparison with FIG. 5, since there is no concave part in the side determining the boundary of a bit, the magnetic moment in the recording magnetic pole is more liable to point perpendicularly to the magnetization transition region between bits. Therefore, the write angle in the magnetization transition region can be made sharper.

### FOURTH EMBODIMENT

FIG. 15 is a perspective view showing a fourth embodiment of the magnetic pole piece 31 of FIG. 3. In the fourth embodiment, a concave part 100a is made in the side of the magnetic pole piece 31 parallel to the track width direction of the disk medium 2 and a concave part 100b is made in the side perpendicular to the track width direction. Let the lengths of the concave parts 100a, 100b in the longitudinal direction be w1 and w2, respectively. Suppose each of w1 and w2 is equal to or more than about half of the track width Tw. The positions in which the concave parts 100a, 100b are made are represented by h1 and h2, respectively. Suppose each of h1 and h2 is about one-third of the neck height NH. The sizes of samples used in experiments conducted in the fourth embodiment are listed in Table 6. Sample (c″″) to sample (h″″) and sample (l″″) to sample (n″″) are the same as sample (c) to sample (h) and sample (l) to sample (n), except that the concave parts 100a, 100b are made. The same materials as in the third embodiment may be used for the composition of the soft magnetic film of the magnetic pole piece 31 of each sample. Then, the amount of head positioning error was measured for each sample.

TABLE 6

| | c″″ | d″″ | e″″ | f″″ | g″″ | h″″ | l″″ | m″″ | n″″ |
|---|---|---|---|---|---|---|---|---|---|
| Track | 0.25 | 0.25 | 0.2 | 0.15 | 0.15 | 0.12 | 0.15 | 0.15 | 0.12 |
| width | | | | | | | | | |
| Tw (μm) | | | | | | | | | |
| Film | 0.3 | 0.2 | 0.2 | 0.2 | 0.15 | 0.12 | 0.2 | 0.15 | 0.12 |
| thickness | | | | | | | | | |
| (μm) | | | | | | | | | |
| Neck | 0.3 | 0.3 | 0.3 | 0.3 | 0.3 | 0.3 | 0.2 | 0.2 | 0.2 |
| height | | | | | | | | | |
| NH (μm) | | | | | | | | | |

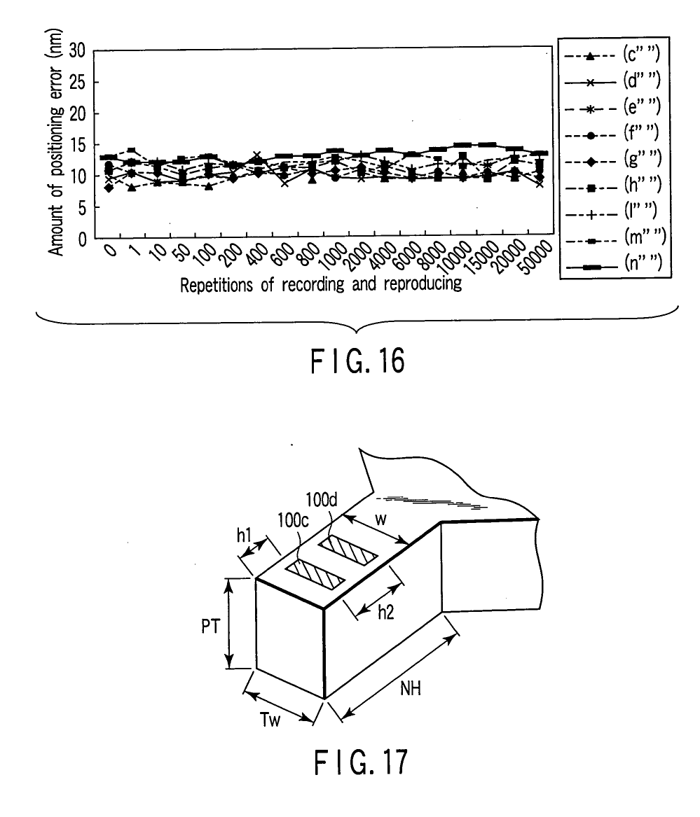

FIG. 16 is a graph showing the result of combining the magnetic pole pieces (with the concave part) of sample (c″″) to sample (n″″) with disk (A) and measuring the positioning error and the number of repetitions of recording and reproducing. As shown in FIG. 16, the positioning error equal to or less than 12 nanometers can be obtained for all of the samples. In addition, in each of the samples, the amount of error did not increase, regardless of the number of recordings. Moreover, even with a combination with disk (B), a similarly stable positioning operation was carried out for all of the heads. Accordingly, it is seen that, in the fourth embodiment, too, positioning control can be stabilized, almost regardless of the thickness of the soft magnetic film of the magnetic disk.

In the fourth embodiment, taking shape anisotropy into account, it can be said that the positions and lengths of the concave parts 100a, 100b provide conditions that make a residual magnetization component heading toward the medium more liable to develop than in the configuration of each of FIGS. 5 and 13 (h: ¼→⅓, w: ¾→½). In spite of this, the result of measuring the positioning error tends to be improved. From this, it is conceivable that forming the concave parts 100a, 100b in sides of the magnetic pole piece 31 in both of the track width direction and bit length direction has the effect of improving the stability of the magnetic pole piece 31 in an unrecording operation.

### FIFTH EMBODIMENT

FIG. 17 is a perspective view showing a fifth embodiment of the magnetic pole piece 31 of FIG. 3. In the fifth embodiment, concave parts 100c, 100d are made in the side of the magnetic pole piece 31 parallel to the track width direction of the disk medium 2. Let the position where the concave part 100c is made be h1. Suppose the concave part 100d is made in a position a distance of h2 away from the disk medium 2 with respect to the concave part 100c. In FIG. 17, let hi be about a quarter of the neck height NH and h2 be about half of the neck height NH. Let the length w of each of the concave parts 100c, 100d be equal to or more than about half of the track width Tw.

In the fifth embodiment, the same samples as sample (c) to sample (h) and sample (l) to sample (n), except that the concave parts 100c, 100c were made, were used. The same materials as in the first to fourth embodiments may be used for the composition of the soft magnetic film of the magnetic pole piece 31 of each sample. Then, the amount of head positioning error was measured for each sample.

As a result of combining the magnetic pole piece (with the concave part) of each of sample (c) to sample (h) and sample (l) to sample (n) with disk (A) and measuring the positioning error and the number of repetitions of recording and reproducing, almost the same graph as in FIG. 16 was obtained. That is, the positioning error equal to or less than 12 nanometers could be obtained for all of the samples. In each of the samples, the amount of error did not increase, regardless of the number of recordings. In addition, even with a combination with disk (B), a similarly stable positioning operation was carried out for all of the heads. Accordingly, it is seen that, in the fifth embodiment, too, positioning control can be stabilized, almost regardless of the thickness of the soft magnetic film of the magnetic disk.

In the fifth embodiment, taking shape anisotropy into account, it can be said that the positions and lengths of the concave parts 100c, 100d provide conditions that make a residual magnetization component heading toward the medium more liable to develop than in the configuration of each of FIGS. 5 and 13 (w: ¾→½). In spite of this, the result of measuring the positioning error tends to be improved. From this, it is conceivable that forming the two concave parts 100c, 100d in the side of the magnetic pole piece 31 in the track width direction has the effect of improving the stability of the magnetic pole piece 31 in an unrecording operation.

Furthermore, in the fifth embodiment, similar experiments were conducted on a sample which was such that two concave parts were made in the side of the magnetic pole piece 31 perpendicular to the track width direction of the disk medium 2 (that is, in the bit length direction) and h1, h2, and w were the same as in FIG. 17. The result was the same as when the concave parts 100c, 100d were formed in the side of the magnetic pole piece 31 parallel to the track width direction of the disk medium 2.

Therefore, making concave parts in the same side can be considered to have the effect of improving the stability of the magnetic pole piece 31 in an unrecording operation, regardless of whether the concave parts are made in the side in either the track width direction or the bit length direction. In addition, the effect of the width of the concave part can be considered. When two or more concave parts are made, a still greater effect can be expected.

In each of the above embodiments, it is desirable that the width of the magnetic pole piece 31 in the track width direction should be 0.3 micrometers or less. The reason for this is to further decrease the possibility that the residual magnetization component heading toward the disk medium 2 in an unrecording operation will remain. In addition, in each of the above embodiments, it is desirable that the neck height NH should be made longer than the recording magnetic pole width. In this case, too, the reason is to further decrease the possibility that the residual magnetization component heading toward the disk medium 2 in an unrecording operation will remain.

Furthermore, in each of the embodiments, when the tip of the magnetic pole piece 31 is designed to have a stacked structure of a nonmagnetic intermediate layer sandwiched between soft magnetic films, it is possible to obtain a magnetostatically more stable state than a single layer. In addition, in each of the embodiments, the effect of suppressing the residual magnetization component can be increased further by making a concave part in a position on the magnetic pole piece 31 equal to or less than half of the neck height from the facing side of the disk medium 2. Moreover, in each of the embodiments, the effect of suppressing the residual magnetization component can be increased further by making the length of the concave part in the longitudinal direction equal to or less than half of the width Tw of the magnetic pole piece 31.

As described above, using the various magnetic heads shown in each of the embodiments makes it possible to suppress the disorder of the recorded information caused by instability in an unrecording operation even in a narrow track head and therefore to provide a more highly reliable vertical magnetic recording apparatus.

This invention is not limited to the above embodiments. For instance, instead of making a concave part, a convex part may be formed. In short, shape anisotropy has only to be produced at the tip of the magnetic pole piece 31. The number of concave parts is not limited to 1 or 2. Since there is a tradeoff between the number of concave parts and the magnetic recording capability, the number of concave parts is expected to have the optimum value. According to the optimum value, the optimum number of concave parts should be made.

Furthermore, in each of the embodiments, the lower limit of the width of the concave part is about 20 nanometers because of the capability of the processing unit. Since it is difficult to evaluate the depth, the limit of the depth is not clear. However, a sufficient effect can be expected, provided that both of the width and depth are in the range of, for example, 5 to 50 nanometers.

In addition, the present invention is not limited directly to the above embodiments and may be practiced or embodied in still other ways without departing from the spirit or essential character thereof. Moreover, various inventions may be contrived by combining a plurality of component elements disclosed in the embodiments. For instance, some component elements may be eliminated from all of the component elements used in one of the embodiments. Furthermore, the component elements used in two or more of the embodiments may be suitably combined.

1. A magnetic recording head which records information on a recording medium by a vertical magnetic recording method, the magnetic recording head comprising:
a magnetic pole piece which generates a recording magnetic flux perpendicular to the recording surface of a recording medium and which includes a side parallel to the track width direction of the recording medium, and
a concave part which is made concavely in the side parallel to the track width direction of the recording medium so as to have a longitudinal direction parallel to the recording surface, with the length of the magnetic pole piece in the track width direction of the recording medium being equal to 0.3 micrometers or less.

2. A magnetic recording head which records information on a recording medium by a vertical magnetic recording method, the magnetic recording head comprising:
a magnetic pole piece which generates a recording magnetic flux perpendicular to the recording surface of a recording medium and which includes
a side perpendicular to the track width direction of the recording medium, and
a concave part which is made concavely in the side perpendicular to the track width direction of the recording medium so as to have a longitudinal direction parallel to the recording surface.

3. The magnetic recording head according to claim 2, wherein the length of the magnetic pole piece in the track width direction of the recording medium is equal to or less than 0.3 micrometers.

4. The magnetic recording head according to claim 1, wherein the length of the magnetic pole piece in the track width direction of the recording medium is less than the length of the magnetic pole piece in the direction in which the recording flux is generated.

5. The magnetic recording head according to claim 2, wherein the length of the magnetic pole piece in the track width direction of the recording medium is less than the length of the magnetic pole piece in the direction in which the recording flux is generated.

6. The magnetic recording head according to claim 1, wherein the length of the concave part in the longitudinal direction is greater than half of the length of the side in which the concave part is made, in a direction parallel to the recording surface.

7. The magnetic recording head according to claim 2, wherein the length of the concave part in the longitudinal direction is greater than half of the length of the side in which the concave part is made, in a direction parallel to the recording surface.

8. The magnetic recording head according to claim 1, wherein a plurality of units of the concave part are made in the same side.

9. The magnetic recording head according to claim 2, wherein a plurality of units of the concave part are made in the same side.

10. The magnetic recording head according to claim 1, wherein the concave part is made in the side in such a manner that the concave part is closer to the recording medium than the midpoint of the length of the magnetic pole piece in the direction in which the recording flux is generated.

11. The magnetic recording head according to claim 2, wherein the concave part is made in the side in such a manner that the concave part is closer to the recording medium than the midpoint of the length of the magnetic pole piece in the direction in which the recording flux is generated.

12. The magnetic recording head according to claim 1, wherein the magnetic pole piece has, at least in the vicinity of the recording medium, a stacked structure that causes a nonmagnetic intermediate layer to intervene between a plurality of soft magnetic films.

13. The magnetic recording head according to claim 2, wherein the magnetic pole piece has, at least in the vicinity of the recording medium, a stacked structure that causes a nonmagnetic intermediate layer to intervene between a plurality of soft magnetic films.

14. A head suspension assembly comprising a magnetic recording head according to claim 1 and a support mechanism which supports the magnetic head in such a manner that the head faces the recording surface of the recording medium.

15. A magnetic recording apparatus comprising a magnetic recording head according to claim 1 and by recording the information on the recording medium by use of the magnetic recording head.

16. The magnetic recording apparatus according to claim 15, wherein the recording medium includes
a soft magnetic underlayer, and
a vertically oriented magnetic recording layer stacked on the soft magnetic underlayer.

17. A composite head comprising:
a magnetic recording head according to claim 1;
a reproduction head which reads information recorded on the recording medium by use of the magnetic recording head; and
a slide mechanism which has the magnetic recording head and the reproduction head both mounted thereon and slides the magnetic recording head and the reproduction head with respect to the recording surface.

18. A head suspension assembly comprising a composite head according to claim 17 and a support mechanism which supports the composite head in such a manner that the composite head faces the recording surface of the magnetic recording medium.

19. A magnetic recording and reproducing apparatus comprising a composite head according to claim 17 and by recording the information on the recording medium by use of the composite head and reading the recorded information by use of the composite head.

20. The magnetic recording and reproducing apparatus according to claim 19, wherein the recording medium includes
a soft magnetic underlayer, and
a vertically oriented magnetic recording layer stacked on the soft magnetic underlayer.
